(19) United States
(12) Patent Application Publication
(10) Pub. No.: US 2006/0140569 A1
(43) Pub. Date: Jun. 29, 2006

(54) Planar waveguides with air thin films used as anti-reflective layers, beam splitters and mirrors

(75) Inventor: Mark E. McDonald, Mill Valley, CA (US)

Correspondence Address: MARSHALL, GERSTEIN & BORUN LLP (INTEL), 233 S. WACKER DRIVE, 6300 SEARS TOWER, CHICAGO, IL, 60606, US

(73) Assignee: INTEL CORPORATION, Santa Clara, CA (US)

(21) Appl. No.: 11/171,135

(22) Filed: Jun. 30, 2005

Related U.S. Application Data
(63) Continuation-in-part of application No. 11/023,711, filed on Dec. 28, 2004.

(51) Int. Cl. G02B 6/10; G02B 6/12

(52) U.S. Cl. 385/129; 385/14

(57) ABSTRACT

Integrated structures including a waveguide that passes through each of the sections, with the waveguide further including an in-waveguide mirror, a beam splitter or an anti-reflective element. The in-waveguide mirror, beam splitter or anti-reflective element are formed by using one or more focused ion beam (FIB) cuts or slits through the waveguide. The cuts or slits used for the mirrors, beam splitters and anti-reflective elements all have high aspect ratios. The mirrors include one slit extending through the core, perpendicular to an axis of the core; the beam splitters include a single slit extending through the core at an angle with respect to an axis of the core; and the anti-reflective elements include a pair of spaced apart slits extending through the core, perpendicular to an axis of the core.

### CROSS-REFERENCE OF RELATED APPLICATION

This is a continuation-in-part of co-pending U.S. patent application Ser. No. 11/023,711, filed on Dec. 28, 2004, still pending.

### BACKGROUND

1. Technical Field

This disclosure relates generally to optical communication systems and, more specifically to planar waveguides that include in-line mirrors, beam splitters and anti-reflective films formed using voids or slits cut in the waveguide structure and transverse to the axis of the waveguide.

2. Description of the Related Art

The demand for increased bandwidth in fiber optic telecommunications has driven the development of sophisticated transmitter lasers suitable for dense wavelength division multiplexing (DWDM) that require the concurrent propagation of multiple data streams through a single optical fiber. Each data stream is created by a modulated output of a semiconductor laser at a specific channel frequency or wavelength. The multiple modulated outputs are combined onto the single fiber.

The International Telecommunications Union (ITU) presently requires channel separations of approximately 0.4 nanometers, or about 50 GHz, which allows up to 128 channels to be carried by a single fiber within the bandwidth range of currently available fibers and fiber amplifiers. Greater bandwidth requirements will likely result in smaller channel separations in the future.

DWDM systems for telecommunications have largely been based on distributed feedback (DFB) lasers. DFB lasers are stabilized by a non-adjustable wavelength selective grating. Unfortunately, statistical variations associated with the manufacture of individual DFB lasers results in a distribution of wavelength channel centers. Hence, to meet the demands for operation and temperature sensitivity during operation on the fixed grid of telecom wavelengths complying with the ITU grid, DFBs have been augmented by external reference etalons or filters and require feedback control loops. Variations in DFB operating temperatures permit a range of operating wavelengths enabling servo control. However, conflicting demands for high optical power, long lifetime, and low electrical power dissipation have prevented use of DFB's in applications that require more than a single channel or a small number of adjacent channels.

Continuously tunable external cavity lasers (ECL) or external cavity diode lasers (ECDL) have been developed to overcome the limitations of individual DFB devices. Many laser tuning mechanisms have been developed to provide external cavity wavelength selection, such as mechanically tuned gratings used in transmission and reflection. External cavity laser tuning must be able to provide a stable, single mode output at a selected wavelength while effectively suppressing lasing associated with external cavity modes that are within the gain bandwidth of the cavity. Achieving these goals typically has resulted in increased, size, cost, complexity and sensitivity in tunable external cavity lasers.

DBR lasers are very similar to DFB lasers. The major difference is that where DFB lasers have a grating within the active region of the cavity, DBR lasers have a partitioned cavity with the grating in a region that is not active (i.e., amplifying). While this provides some isolation from the chirp effect inherent with DFB designs, the tuning characteristics of tunable DBR lasers still leave much to be desired.

The inherent advantage of the ECDL design over the highly integrated DFB and DBR designs is the fact that the tunable filter of the ECDL is decoupled from the gain region, and therefore can be made very stable. As a result, unlike DFB and DBR lasers, ECDL's may not require external wavelength lockers. The separate tuner in an ECDL may be controlled with essentially no cross-talk to other controlled parameters, such as laser diode current, and this can lead to simplified and more robust tuning algorithms than are typical of fully-integrated tunable lasers.

On the other hand, the lack of integration in the conventional ECDL design leads to additional parts or components and makes manufacturing of ECDL more labor-intensive and costly. In addition, phase control of existing ECDL designs is slow with respect to requirements for next-generation fast-tuning lasers.

Further, common waveguide splitters or combiners are of two distinct forms. First, gratings can be formed by manipulating waveguide dimensions and therefore alternating the propagation constant. The second type is or waveguide couplers which require significant space on a chip to avoid radiation losses due to bending. Gratings are limited to the small index contrast that is available, which can lead to a grating that is very low in reflectivity or which has a narrow bandwidth.

Mirrors or reflective surfaces are also very difficult to incorporate onto a chip as they present significant alignment problems. Specifically, it is very difficult to install and align conventional reflective devices in a ECL or ECDL device.

### BRIEF DESCRIPTION OF THE DRAWINGS

Various aspects and advantages of the disclosed embodiments will become apparent upon reference to the following detailed description, when taken in conjunction with the accompanying drawings, wherein like reference numerals refer to like or similar parts throughout the various views unless otherwise specified:

FIG. 1 is a schematic diagram of a conventional external cavity laser from which various disclosed embodiments may be derived;

FIG. 2 is a schematic diagram illustrating a conventional laser cavity defined by a partially-reflective front facet of a Fabry-Perot gain chip and a reflective element;

FIG. 3 is a diagram illustrating a relative position of a laser cavity's lasing modes with respect to transmission peaks defined by an intra-cavity etalon and channel selector;

FIG. 4 is a schematic diagram illustrating a semi-integrated external-cavity diode laser (ECDL) configuration including an integrated structure having gain, and modulator sections that are optically-coupled via a tilted waveguide having an in-waveguide mirror formed using a focused ion beam (FIB) cut, according to one disclosed embodiment;

FIG. 5 is a schematic diagram illustrating further details of the integrated structure of FIG. 4;

FIG. 6 is a labeled image derived from a scanning electron microscope showing a cross-section of an FIB cut formed in a ridge waveguide structure;

FIG. 7 is a schematic diagram illustrating a cross-section of an exemplary ridge waveguide structure;

FIG. 8 illustrates, schematically, a mirror element made from a FIB cut into a waveguide structure as illustrated in FIGS. 6 and 7;

FIG. 9 illustrates, schematically, a beam splitter element integrated into a waveguide structure by making a FIB cut into the waveguide structure similar to that illustrated in FIGS. 6 and 7; and

FIG. 10 illustrates an anti-reflection element integrated into a waveguide by making two spaced apart and generally parallel FIB cuts into the waveguide structure.

### DETAILED DESCRIPTION OF THE PRESENTLY PREFERRED EMBODIMENTS

Embodiments of laser apparatuses that employ a semi-integrated designs including integrated structures with in-waveguide mirrors, beam splitters and anti-reflection membranes and methods for manufacturing the integrated structures are described herein. In the following description, numerous specific details are set forth to provide an understanding of disclosed embodiments. One skilled in the relevant art will recognize, however, that the disclosed embodiments can be practiced without one or more of the specific details, or with other methods, components, materials, etc. In other instances, well-known structures, materials, or operations are not shown or described in detail to avoid obscuring aspects of this disclosure.

The disclosed embodiments described below employ a semi-integrated design for tunable lasers, such as external cavity tunable lasers. In order to better understand and appreciate aspects of these embodiments, a brief discussion of the operation and design of conventional external cavity tunable lasers is now presented.

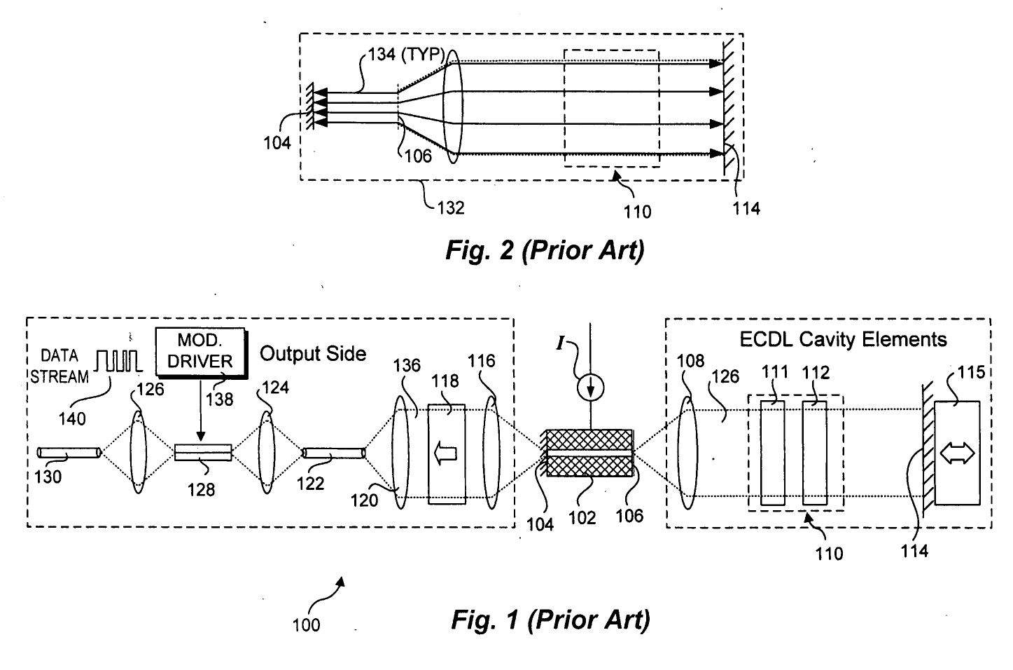

Discrete wavelength tunable diode lasers typically comprise a semiconductor gain medium, two reflectors, and an intra-cavity tuning mechanism. For example, as an overview, a generalized embodiment of an external cavity diode laser (ECDL) 100 configured for optical communication is shown in FIG. 1. ECDL 100 includes a gain medium comprising a diode gain chip 102. Diode gain chip 102 comprises a Fabry-Perot diode laser including a partially-reflective front facet 104 and a substantially non-reflective rear facet 106 coated with an anti-reflective (AR) coating to minimize reflections at its face. Optionally, diode gain chip 102 may comprise a bent-waveguide structure on the gain medium to realize the non-reflective rear facet 106 (not shown). The external cavity elements include a diode intracavity collimating lens 108, tuning filter element or elements 110 (e.g., etalons 111 and 112), and a reflective element 114. In general, reflective element 114 may comprise a mirror, grating, prism, or other reflector or retro-reflector that may also provide the tuning filter function in place of tuning element 110. Also depicted as an ECDL cavity element is a path length modulation element 115. This element, which typically comprises a mechanical or thermal actuator, or an electro-optical element, is employed to modulate (dither) the optical path length of the laser cavity to induce a perturbation from which an error signal can be derived, as described below in further detail.

In addition to the ECDL cavity elements, a conventional communication laser of this type employs several output side elements used for isolation and data modulation. The output side elements illustrated in FIG. 1 include a diode output collimating lens 116, an optical isolator 118, a fiber focusing lens 120, a fiber pigtail 122 a pair of coupling lenses 124 and 126, a modulator 128 and an output fiber segment 130.

The basic operation of ECDL 100 of FIG. 1 is a follows. A controllable current I is supplied to diode gain chip 102 (the gain medium), resulting in a voltage differential across the diode junction, which produces an emission of optical energy (photons). The emitted photons pass back and forth between partially-reflective front facet 104 and reflective element 114, which collectively define the ends of an “effective” laser cavity (i.e., the two reflectors discussed above), as depicted by laser cavity 132 in FIG. 2. As the photons pass back and forth, a plurality of resonances, or “lasing” modes are produced. Under a lasing mode, a portion of the optical energy (photons) temporarily occupies the external laser cavity, as depicted by an intracavity optical beam depicted as light rays 134; at the same time, a portion of the photons in the external laser cavity eventually passes through partially-reflective facet 104.

Light comprising the photons that exit the laser cavity through partially-reflective front facet 104 passes through diode output collimating lens 116, which collimates the light into a light beam 136. The output beam then passes through optical isolator 118. The optical isolator is employed to prevent back-reflected light from being passed back into the external laser cavity, and is generally an optional element. After the light beam passes through the optical isolator, it is launched into fiber pigtail 122 by fiber focusing lens 120. Generally, output fiber 122 may comprise a polarization-preserving type or a single-mode type such as SMF-28.

Through appropriate modulation of the input current (generally for communication rates of up to 2.5 GHz) or through modulation of an external element disposed in the optical path of the output beam (e.g., modulator 128, as shown in FIG. 1) (for 10 GHz and 40 GHz communication rates), data can be modulated on the output beam to produce an optical data signal. Such a signal may be launched into a fiber and transmitted over a fiber-based network in accordance with practices well known in the optical communication arts, thereby providing very high bandwidth communication capabilities.

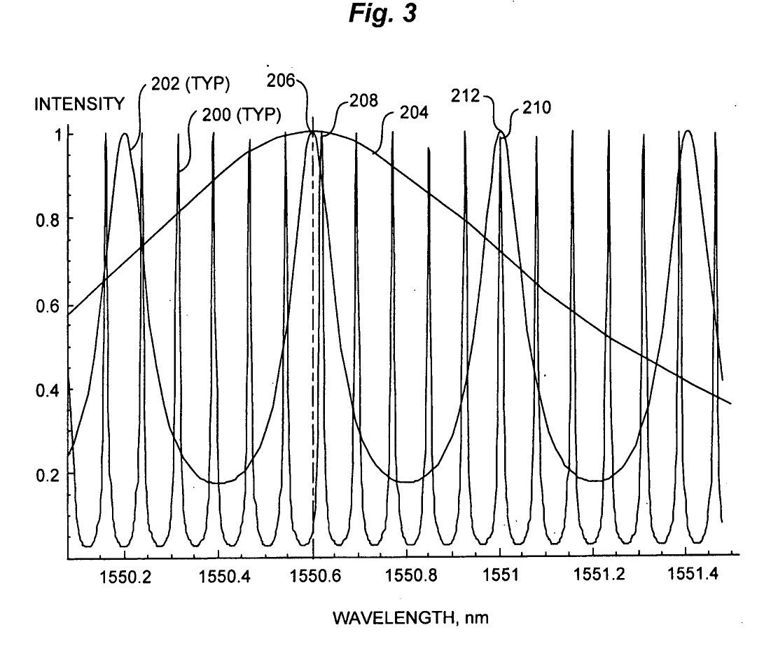

The lasing mode of an ECDL is a function of the total optical path length between the cavity ends (the cavity optical path length); that is, the optical path length encountered as the light passes through the various optical elements and spaces between those elements and the cavity ends defined by partially-reflective front facet 104 and reflective element 114. This includes diode gain chip 102, diode intracavity collimating lens 108, tuning filter elements 110, plus the path lengths between the optical elements (i.e., the path length of the transmission medium occupying the ECDL cavity, which is typically a gas such as air). More precisely, the total optical path length is the sum of the path lengths through each optical element and the transmission medium times the coefficient of refraction for that element or medium. As discussed above, under a lasing mode, photons pass back and forth between the cavity end reflectors at a resonance frequency, which is a function of the cavity optical path length. In fact, without the tuning filter elements, the laser would resonate at multiple frequencies, producing a multi-mode output signal. Longitudinal laser modes occur at each frequency where the roundtrip phase accumulation is an exact multiple of 2π. For simplicity, if we model the laser cavity as a Fabry-Perot cavity, these frequencies can be determined from the following equation:

$$L = \frac{λ x}{2 n} \qquad ( 1 )$$

where λ=wavelength, L=optical length of the cavity, x=an arbitrary integer −1, 2, 3, . . . , and n=refractive index of the medium. The average frequency spacing can be derived from equation (1) to yield:

$$Δ v = \frac{c}{2 nL} \qquad ( 2 )$$

where v=c/λ and c is the speed of light. The number of resonant frequencies is determined from the width of the gain spectrum. The corresponding lasing modes for the cavity resonant frequencies are commonly referred to as “cavity modes,” an example of which is depicted by cavity modes 200 in FIG. 3.

Semiconductor laser gain media typically have broad gain spectra and therefore require spectral filtering to achieve single longitudinal mode operations (i.e., operations at a single wavelength or frequency). In order to produce an output at a single frequency, filtering mechanisms are employed to substantially attenuate all lasing modes except for the lasing mode corresponding to the desired frequency. As discussed above, in one scheme a pair of etalons, depicted as a grid generator 111 and a channel selector 112 in FIG. 1, are employed for this filtering operation. A grid generator, which comprises a static etalon that operates as a Fabry-Perot resonator, defines a plurality of transmission peaks (also referred to as pass bands) in accordance with equations (1) and (2).

Ideally, during operation the transmission peaks remained fixed, hence the term “static” etalon; in practice, it may be necessary to employ a servo loop (e.g., a temperature control loop) to maintain the transmission peaks at the desired location. Since the cavity length for the grid generator is less than the cavity length for the laser cavity, the spacing (in wavelength) between the transmission peaks is greater for the grid generator than that for the cavity modes. A set of transmission peaks 202 corresponding to an exemplary etalon grid generator is shown in FIG. 3. Note that at the peaks of the waveform the intensity (relative in the figure) is a maximum, while it is a minimum at the troughs. Generally, the location and spacing of the transmission peaks for the grid generator will correspond to a set of channel frequencies defined by the communication standard the laser is to be employed for, such as the ITU channels and 0.04 nanometer (nm) spacing discussed above and depicted in FIG. 3. Furthermore, the spacing of the transmission peaks corresponds to the free spectral range (FSR) of the grid generator.

A channel selector, such as an adjustable etalon, is employed to select the lasing mode of the laser output. For illustrative purposes, in one embodiment channel selector 112 may comprise an etalon having a width substantially less than the etalon employed for the grid generator. In this case, the FSR of the channel selector is substantially larger than that of the grid generator; thus the band pass waveform of the channel selector is broadened, as illustrated by channel selector band pass waveform 204 having a single transmission peak 206. In accordance with this channel selection technique, a desired channel can be selected by aligning the single transmission peak of the channel selector (e.g. 206) with one of the transmission peaks of the grid generator. For example, in the illustrated configuration depicted in FIG. 3, the selected channel has a frequency corresponding to a laser output having a 1550.6 nm wavelength.

In addition to the foregoing scheme, several other channel selecting mechanisms may be implemented, including rotating a diffraction grating; electrically adjusting a tunable liquid crystal etalon; mechanically translating a wedge-shaped etalon (thereby adjusting its effective cavity length); and “Vernier” tuning, wherein etalons of the same finesses and slightly different FSRs are employed, and a respective pair of transmission peaks from among the transmission peaks defined by the etalons are aligned to select the channel in a manner similar to that employed when using a Vernier scale.

As discussed above, other types of tunable laser designs have been considered and/or implemented. In addition to DFB lasers, these include Distributed Bragg Reflector (DBR) lasers. Both DBR and DFB lasers are considered “integrated” lasers because all of the laser components are integrated in a common component. While this is advantageous for manufacturing, an integrated scheme means tuning is coupled to laser diode operation. This results in lower tuning quality when compared with ECDLs.

For example, DFB lasers have a problem with aging. More specifically, as a DFB laser is used, the characteristics of the gain section change over time. This phenomena is known as “aging.” Aging results in a wavelength shift, since the frequency reference and the active gain section are coupled in one chip. In contrast, the frequency reference (i.e., filter elements) are de-coupled from the gain chip for ECDL's, providing improved frequency stability over time. Another advantage of ECDLs over DFB lasers is spectral characteristics. The much longer lasing cavity in ECDLs provides very narrow line width and very good side-mode suppression ratios.

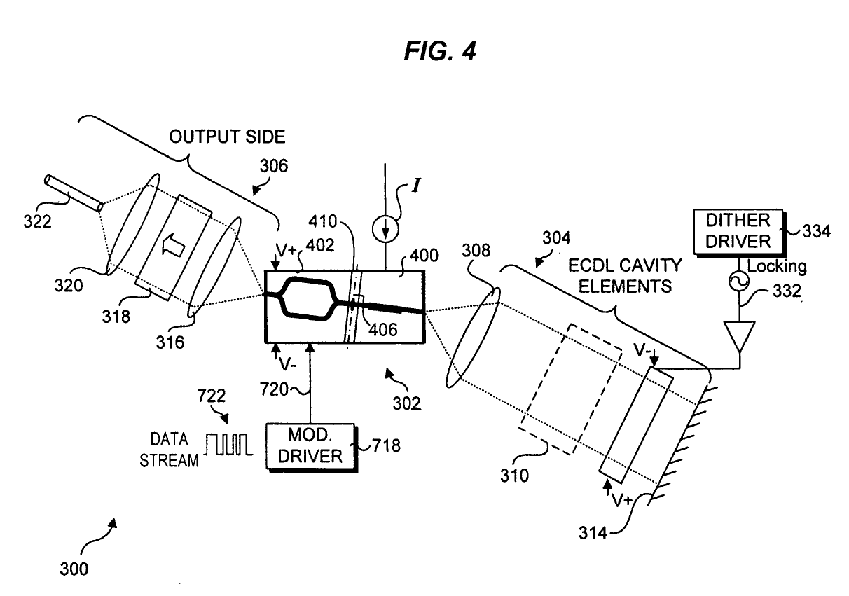

FIG. 4 shows semi-integrated ECDL 300 corresponding to one exemplary embodiment. ECDL 300 includes an integrated structure 302 optically coupled between a set of ECDL cavity elements 304 and a set of output side elements 306.

In general, the set of ECDL cavity element 304 will be substantially analogous to those discussed above with reference to FIG. 1. For example, a typical set of ECDL cavity elements may include a collimating lens 308, a tuning filter element or elements 310, and a reflective element 314. Details of an exemplary tuning filter are discussed below. In general, reflective element 314 may comprise a mirror, grating, prism, or other reflector or retro reflector, which may also provide the tuning filter function in place of tuning filter element 310. ECDL cavity element 304 of FIG. 4 further includes a phase modulator 312.

The outputs side elements 306 for the semi-integrated ECDL laser 302 is analogous to those described above with reference to FIG. 1 pertaining to the isolation function. These include a collimating lens 316, an optical isolator 318, a fiber focusing lens 320, and an output fiber 322.

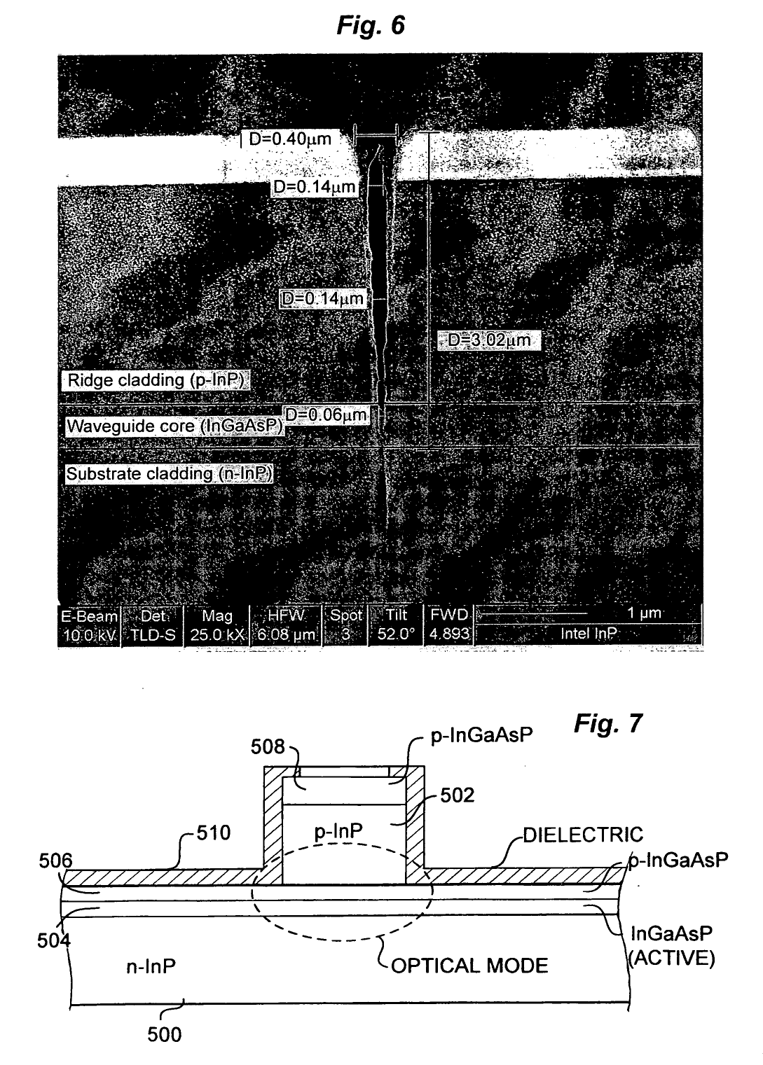

Still referring to FIG. 4, the integrated structure includes a gain section 400 and a modulator section 402. The gain and modulator sections for integrated structure 302 are optically coupled via a waveguide 406. The integrated structure 302, includes a mirror 408 is formed within the waveguide 406 in a portion of the waveguide between gain section 400 and modulator section 402. As described in further detail with reference to FIG. 6, the mirror 408 is formed by a high-aspect ratio gap defined perpendicular to (a longitudinal axis passing through the core of) waveguide 406. For clarity, mirror 408 is shown as being disposed in a mirror section 410, which in practice represents a very short section of the waveguide 406. It is further noted that the size of the various sections of the integrated structures depicted herein are not to scale and are depicted as shown for clarity, as will be recognized by those skilled in the semiconductor laser art.

The integrated structure 302 includes a non-reflective front facet 411 and a non-reflective rear facet 412. To make the facets non-reflective, an appropriate anti-reflective coating 414 is applied to each of non-reflective facets 411 and 412 in a manner similar to that discussed above for non-reflective facet 106 of FIG. 1.

The integrated structure 302 share similar qualities with respect to how the waveguide 406 is configured at the junctions between the phase control (if included), gain, mirror, and modulator sections. In particular, the configuration of the waveguide 406 is such that it is angled (i.e., non-perpendicular) relative to each of front and rear facets 411 and 412, and at the junctions between the various sections. Furthermore, the integrated structure 302 employs a tilted waveguide geometry. That is, in this configuration the plane in which mirror 410 is formed is tilted at an angle relative to the crystalline plane structure of the substrate material from which integrated structure 302 is formed.

The angled and perpendicular waveguide/facet interfaces are configured as such to take advantage of well-known optical phenomena. More specifically, the optical phenomena concern the behavior of light as it passes between two materials having different indexes of refraction. Depending on the difference between the refractive indexes and angle of incidence, varying amounts of incident power will be reflected back. In the case of normal incidence, substantially all the reflected light is coupled into the waveguide while in the case of the angled incidence (optimum is about 6°) most of the reflected light leaves the waveguide (gets scattered) and therefore does not interact with the cavity light.

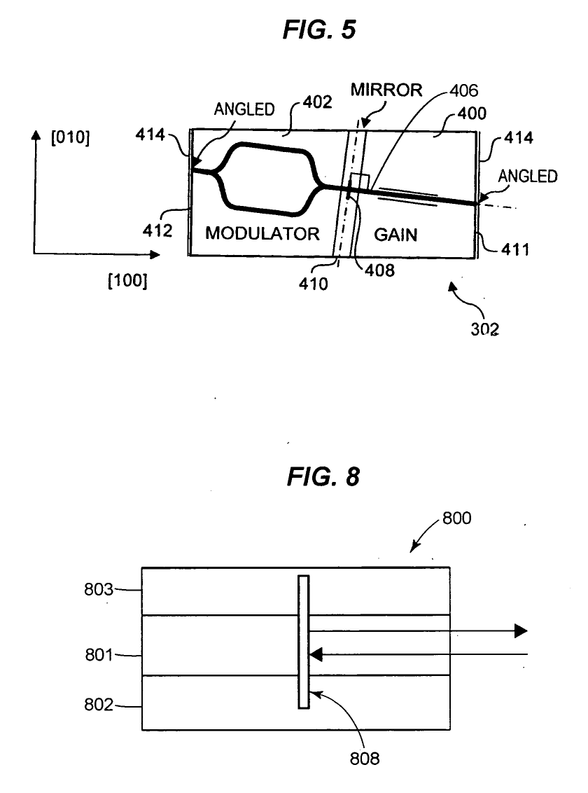

With the foregoing optical phenomena in mind, the embodiment of FIGS. 5 and 6 mirror 408 is formed by removing or altering a planar portion of material along a portion of their respective waveguides depicted in the mirror section 410. This creates a difference between the index of refraction of phase control section 402 and the index of refraction of the gap material (typically a surrounding gas, such as air). This index of refraction difference along with the perpendicular configuration produces a partial reflection at the gap, resulting in a low reflectivity mirror (i.e., 2-10%). Thus, the mirror 408 defines one of the end reflectors for the effective laser cavity of the ECDL 300 with the other end of the laser cavity defined by reflective element 314.

In the meantime, it is not desirable to have additional mirror elements in the laser cavity. Such elements may produce phase interferences, among other problems. Therefore, the angle of waveguide 406 is selected to be non-perpendicular at front and rear facets 411 and 412. In practice, a small portion of light is reflected at the interface plane between materials having dissimilar refractive indexes when the waveguide is tilted or bent. However, the angle tilt with respect to the facet planes provides mode mismatch for the reflected light, and thus doesn't create an interference with the lasing mode to which the laser is tuned.

In an embodiment, the mirror 408 may be formed by using a focused ion beam (FIB). FIB systems operate in a similar fashion to a scanning electron microscope (SEM) except, rather than using a beam of electrons, FIB systems use a finely focused beam of gallium ions that can be operated at low beam currents for imaging or high beam currents for site specific sputtering or milling.

The results of an exemplary FIB milling process that is employed to form a 0.06 micrometer (μm) gap in the ridge waveguide of a gain medium structure is shown in FIG. 6, while an exemplary ridge waveguide structure is shown in FIG. 7. Both structures include substrate cladding 500 comprising n-doped InP, a ridge cladding 502 comprising p-doped InP, and a waveguide core 504 comprising a layer of InGaAsP. As shown in FIG. 7, a typical ridge waveguide structure may further include a p-doped layer of InGaAsP formed above the InGaAsP waveguide layer, and a p-doped layer 506 of InGaAsP 506 disposed above the ridge cladding 508. A dielectric layer 510 may be formed over the top of the structure to insulate and protect the underlying layers.

FIB systems employ a sputtering technique for performing machining of substrates. The gallium (Ga⁺) primary ion beam hits the substrate surface and sputters a small amount of material, which leaves the surface as either secondary ions (i⁺ or i⁻) or neutral atoms (n⁰). The primary beam also produces secondary electrons (e⁻). At low primary beam currents, very little material is sputtered; under this type of operation, an FIB system may be used for imaging, and can achieve 5 nm imaging resolution. At higher primary currents, a great deal of material can be removed by sputtering, allowing precision milling of the specimen down to a sub-micron scale.

FIB systems are able to produce material “cuts” with very-high aspect ratios (cut depth vs. width). However, the sputtering technique does not produce a perfect high-aspect ratio cut. Rather, a kerf is formed, having a greater width at the top of the cut, with the kerf becoming narrower with increasing depth. Ideally, the sidewalls formed by the FIB cut should be (substantially) perpendicular proximate to the section of the cut passing through the waveguide, although some imperfections are tolerable.

Another technique for producing an in-waveguide mirror is to define one or more low-aspect ratio “trenches” through the core of the waveguide, and then backfill the trenches with a material having an appropriate (selectable) index of refraction. As discussed in co-pending application Ser. No. 11/023,711, the number of trenches will generally be dependent on the selected backfill material in view of the desired level of reflectivity to be obtained and the waveguide geometry.

FIG. 8 is a schematic illustration of a waveguide 800 with a core 801 disposed between claddings 802, 803. The reflective element or mirror 808 is formed by making a slit or cut through the waveguide 800 as shown in connection with FIG. 6. The resulting void produces a “air-thin film” which provides a very high index of refraction contrast as n=1.0 for air while n˜3.4 for a typical waveguide core. With such a high index of refraction contrast, the structure shown in FIG. 8 provides significant reflectivity with wide bandwidth. As a result, the air thin film of FIG. 8 provides better tolerances for changes in bandwidth and is therefore very useful for tunable lasers and for use in conditions with significant temperature fluctuations. The shorter structure of FIG. 8 reduces chip size the simple manufacturing process increases yield while decreasing costs.

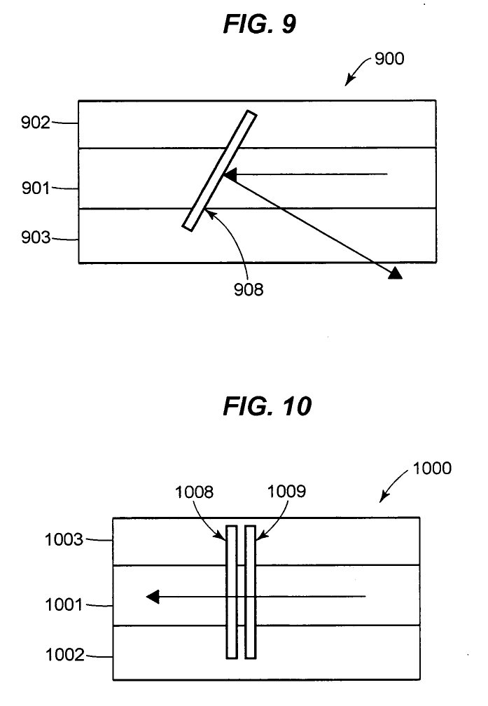

The approach illustrated in FIGS. 6 and 8 is flexible as shown in FIGS. 9 and 10. Specifically, turning to FIG. 9, a waveguide structure 900 is illustrated with a core 901 disposed between cladding s 902, 903. By placing the slit 908 at an angle with respect to the core 901, a beam splitter affect is provided. In contrast, a waveguide 1000 is illustrated in FIG. 10 with a core 1001 sandwiched between claddings 1002, 1003. Through the core 1001 are disposed slits 1008, 1009 which are generally parallel and spaced apart by about 1 μm or more. The spacing and thicknesses of the slits 1008, 1009 will vary. The result is an anti-reflective element.

Thus, as shown in FIGS. 8-10, air-thin films can be used to provide a mirror or reflective element 808, a beam splitter 908 or an anti-reflection element 1008, 1009.

While only certain embodiments have been set forth, alternative embodiments and various modifications will be apparent from the above description to those skilled in the art. These and other alternatives are considered equivalents and within the spirit and scope of this disclosure.

What is claimed is:

1. A waveguide comprising:
a core sandwiched between a lower cladding and an upper cladding, a slit traversing the core, the slit being filled with air.

2. The waveguide of claim 1 wherein the slit extends through the core perpendicular to an axis of the core and reflects an optical beam extending down the core that engages the air disposed within the slit.

3. The waveguide of claim 2 wherein the slit has a high aspect ratio.

4. The waveguide of claim 3 wherein the slit has a width within the core ranging from about 0.1 μm to about 0.04 μm.

5. The waveguide of claim 3 wherein the slit is formed using a focused ion beam.

6. The waveguide of claim 1 wherein the slit extends through the core at an angle with respect to an axis of the core and splits off a portion of an optical beam extending down the core that engages the air disposed within the slit.

7. The waveguide of claim 6 wherein the slit has a high aspect ratio.

8. The waveguide of claim 7 wherein the slit has a width within the core ranging from about 0.1 μm to about 0.04 μm.

9. The waveguide of claim 7 wherein the slit is formed using a focused ion beam.

10. The waveguide of claim 1 further comprising a second slit parallel to the other slit, and wherein the two slits are perpendicular to an axis of the core and transmit an optical beam extending down the core that engages the air disposed within the slits.

11. The waveguide of claim 10 wherein the slits have high aspect ratios.

12. The waveguide of claim 11 wherein the slits each have a width within the core ranging from about 0.1 μm to about 0.04 μm.

13. The waveguide of claim 12 wherein the slits are spaced apart by a spacing ranging from about 1 to about 2 μm.

14. The waveguide of claim 12 wherein the slits are formed using focused ion beams.

15. A planar light wave circuit comprising:
a waveguide comprising
a core sandwiched between a lower cladding and an upper cladding,
an anti-reflective element in the core comprising a pair of spaced apart slits traversing the core, the slits each being filled with air, the two slits being perpendicular to an axis of the core and transmitting an optical beam extending down the core that engages the air disposed within the slits.

16. The planar light wave circuit of claim 15 wherein the slits have high aspect ratios.

17. The planar light wave circuit of claim 16 wherein the slits each have a width within the core ranging from about 0.1 μm to about 0.04 μm.

18. The waveguide of claim 18 wherein the slits are formed using focused ion beams.

19. A planar light wave circuit comprising:
a waveguide comprising
a core sandwiched between a lower cladding and an upper cladding,
an anti-reflective element integrated into the core and comprising a pair of spaced apart high aspect ratio slits traversing the core, the slits each being filled with air, the two slits being perpendicular to an axis of the core and transmitting an optical beam extending down the core that engages the air disposed within the slits, the slits being formed using focused ion beams.

20. The planar light wave circuit of claim 19 wherein the slits each have a width within the core ranging from about 0.1 μm to about 0.04 μm, and
wherein the slits are spaced apart by a spacing ranging from a bout 1 to about 2 μm.
